(19) United States
(12) Patent Application Publication
(10) Pub. No.: US 2017/0206569 A1
(43) Pub. Date: Jul. 20, 2017

(54) Reviewing Messages Presented During a Stream of Media Content

(71) Applicant: Pandora Media, Inc., Oakland, CA (US)

(72) Inventors: David Reiley, Berkeley, CA (US); Bradley Richard Beal, San Francisco, CA (US); Andrew Hammond, Oakland, CA (US); Alan Chappell, Oakland, CA (US)

(21) Appl. No.: 15/405,549

(22) Filed: Jan. 13, 2017

Related U.S. Application Data
(60) Provisional application No. 62/278,933, filed on Jan. 14, 2016.

(51) Int. Cl. G06Q 30/02; H04L 29/06

(52) U.S. Cl. CPC G06Q 30/0277; H04L 65/4084; H04L 65/1063; H04L 67/42

(57) ABSTRACT

A content server generates an ad review display that allows users to review previously-presented ads. The content server provides a stream of media content to a client device for presentation to a user of the client device, and generates an ordered list comprising ad tiles corresponding to ads presented to the user with the stream of media content. The content server generates an ad review display based on the ordered list. The ad review display comprises one or more ad tiles organized along a first axis of the ad review display according to their position in the ordered list. The content server sends the ad review display to the client device for presentation to the user. Responsive to receiving a request to replay a previously-presented ad from the client device, the content server inserts the ad into the stream of media content being provided to the client device.

### CROSS-REFERENCE TO RELATED APPLICATIONS

This application claims the benefit of U.S. Provisional Patent Application No. 62/278,933, filed on Jan. 14, 2016, which is hereby incorporated by reference.

### BACKGROUND

Field of Disclosure

The present invention generally relates to streaming media with interspaced messages, and more specifically allowing users to review messages interspaced in streaming media.

Description of the Related Art

Providers of digital content may generate revenue by inserting advertisements into the digital content and receiving payment from advertisers. For example, the providers may insert audio or video advertisements between songs in an audio content stream provided to client devices. When an advertisement is inserted into digital content, the user is forced to listen to or watch the advertisement if they would like to resume the digital content.

However, once the advertisement has played and the digital content resumes, the advertisement is typically not recoverable by the user. That is, the user is not able to look back at earlier-presented advertisements. This lack of function reduces the advertisements' effectiveness because users who have decided that they want to engage with an advertisement toward the end of or after the advertisement may not be able to access it again.

### SUMMARY

The above and other needs are met by methods, non-transitory computer-readable storage media, and systems for generating an advertisement review display.

One aspect provides a computer-implemented method for generating an advertisement review display. The method includes providing a stream of media content to a client device for presentation to a user of the client device, and generating an ordered list comprising a plurality of ad tiles corresponding to a plurality of previously-presented ads, where the previously-presented ads have been presented to the user in conjunction with the stream of media content. The method also includes generating an ad review display based on the ordered list, where the ad review display comprises one or more ad tiles of the plurality of ad tiles organized along a first axis of the ad review display according to their position in the ordered list. The method further includes sending the ad review display to the client device for presentation to the user, receiving a request to replay a first ad from the client device, and inserting the first ad into the stream of media content being provided to the client device.

Another aspect provides a non-transitory computer-readable storage medium storing computer program instructions executable for generating an advertisement review display. The non-transitory computer-readable storage medium stores computer program instructions for providing a stream of media content to a client device for presentation to a user of the client device, and generating an ordered list comprising a plurality of ad tiles corresponding to a plurality of previously-presented ads, where the previously-presented ads have been presented to the user in conjunction with the stream of media content. The computer program instructions also include generating an ad review display based on the ordered list, where the ad review display comprises one or more ad tiles of the plurality of ad tiles organized along a first axis of the ad review display according to their position in the ordered list. The computer program instructions further include sending the ad review display to the client device for presentation to the user, receiving a request to replay a first ad from the client device, and inserting the first ad into the stream of media content being provided to the client device.

Still another aspect provides a computer system for generating an advertisement review display. The computer system includes the non-transitory computer-readable storage medium storing executable computer program instructions described above. The computer system additionally includes a processor for executing the computer program instructions.

### BRIEF DESCRIPTION OF DRAWINGS

FIG. 1 is a high-level block diagram illustrating an embodiment of an environment for reviewing advertisements from a playlist of media items, according to one embodiment.

FIG. 2 is a high-level block diagram illustrating a detailed view of the content server of FIG. 1, according to one embodiment.

FIG. 3 is a high-level block diagram illustrating a detailed view of the application on the client device of FIG. 1, according to one embodiment.

FIGS. 4A-B are example user interfaces provided by the application of FIGS. 1 and 3, according to one embodiment.

FIGS. 5A-5D are example ad review displays in the example user interface of FIG. 4B, according to one embodiment.

FIG. 6 is a flowchart illustrating a process of displaying previously-presented advertisements to a user for review, according to one embodiment.

FIG. 7 is a high-level block diagram illustrating an example computer for implementing the entities shown in FIG. 1.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

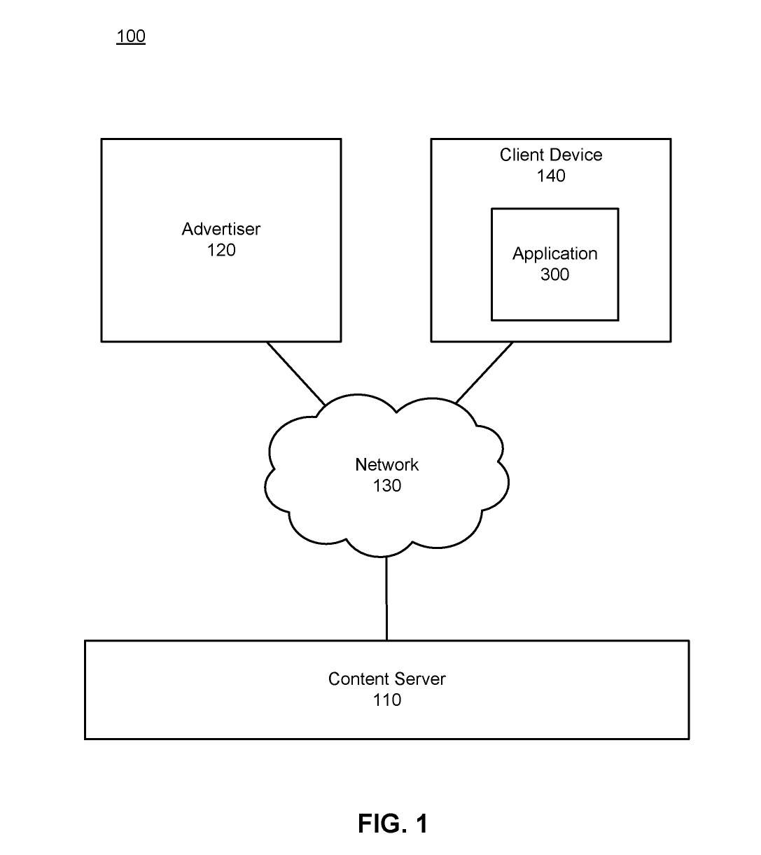

FIG. 1 is a high-level block diagram illustrating a computing environment 100 for reviewing advertisements (also referred to as “ads”) presented in association with a media playlist, according to one embodiment. The environment includes entities such as a content server 110, an advertiser 120, and a client device 140. Here only one content server 110, one advertiser 120 and one client device 140 are illustrated but there may be multiple instances of each of these entities. For example, there may be thousands or millions of advertisers 120 and client devices 140 in communication with one or more content servers 110. In some embodiments, the content servers 110 are split into dedicated music and ad servers.

The content server 110 provides media content to the client device 140 in the form of playlists of media items. In one embodiment, the content server 110 provides streamed audio content, but the content server 110 may alternatively or additionally provide other forms of media, such as videos, animations, movies, slideshows, images, or video games. Audio content refers to media having an audio component. In one particular embodiment referred to throughout the specification, the content server 110 provides streamed audio. Subsequent references to “playing” or other audio-related terminology could equally apply to (for example) presenting videos or otherwise providing media from the content server 110 to the client device 140.

The content server 110 provides ads to the client device 140. An ad refers to content containing a marketing communication, which is typically delivered in exchange for a consideration (e.g., monetary compensation) from an advertiser 120. Ads may be interspersed with or incorporated into non-ad content, such as a stream of audio content. Ads are classified into different types based on how they present ad content. These types include “banner” ads, and “in-stream” ads. Banner ads are presented visually on the client device 140 while other media content is being played. For example, a banner ad may be an image that is displayed while audio content is being streamed. In-stream ads are incorporated into the media content that is being played. For example, the content server 110 provides a stream of audio content including ads interspersed between songs. Alternatively or additionally, the content server 130 incorporates ads into animation, video, or game content. In one particular embodiment referred to throughout the specification, ads are primarily ads containing audio content. However, ads may also contain and/or be associated with image, video or other media content.

“Advertisers” 120 are entities that provide ad text, targeting criteria, and other ad preferences to the content server 110. Advertisers 120 refers both to people or organizations that create ads and to the systems used to communicate with the content system 110 (e.g., computers). Targeting criteria indicate characteristics of users to receive an ad.

The content server 110, the advertisers 120, and the client devices 140 are connected via a network 130. The network 130 may be any suitable communications network for data transmission. The network 130 is typically the Internet, but may be any network, including but not limited to a Local Area Network (LAN), a Metropolitan Area Network (MAN), a Wide Area Network (WAN), a mobile wired or wireless network, a private network, or a virtual private network.

The client device 140 is a computing device such as a smartphone with an operating system such as ANDROID® or APPLE® IOS®, a tablet computer, a laptop computer, a desktop computer, an electronic stereo in an automobile or other vehicle, or any other type of network-enabled device on which digital content may be listened to or otherwise experienced. Typically the client device 140 includes the hardware and software needed to input and output sound (e.g., speakers and microphone) and images, connect to the network 130 (e.g., via WiFi and/or 4G or other wireless telecommunication standards), determine the current geographic location of the client devices 140 (e.g., a Global Positioning System (GPS) unit), and/or detect motion of the client devices 140 (e.g., via motion sensors such as accelerometers and gyroscopes).

The client device 140 includes an application 300 that interacts with the content server 110. For example, the application 300 could be a browser that allows a user of the client device 140 to obtain content by browsing a web site of the content server 110. As another example, the application 300 could be a dedicated application specifically designed (e.g., by the organization responsible for the content server 110) to enable interactions with the content server 110 and its content. In addition to allowing a user to obtain content from the content server 110, the application may also provide the content server 110 with data about the status and use of the client device 140, such as its network identifier and geographic location. In some embodiments, the user of the application may elect to disable sending data about the status and use of the client device 140 to the content server 110.

The application 300 on a particular client device 140 may be associated with a user of the client device 140 (e.g., via a one-time registration, or a username and password pair or other credentials). When the application 300 is associated with a user, the application 300 can store or otherwise gain access to user information such as user profile data (e.g., interests, demographics, content preferences, location). User information may be expressly provided through the application 300 to configure a user profile on the content server 110.

The application 300 presents media items, responsive to a user selecting and/or creating a particular media channel. A media channel is a playlist of media items that are grouped together, where the media items share one or more common media features. A media item is a form of media content and is characterized by a set of media features that describe musicological features of the item (e.g., gender of singer, tempo, style). In one particular embodiment referred to throughout the remainder of the specification, the media item is audio content, such as a song, piece of music, or audio recording. It is appreciated, however, that in other embodiments a media item alternatively and/or additionally include other forms of digital content, such as a video, movie, slideshow, or image. Thus, subsequent references to the media item or other audio-related terminology could equally apply to (for example) viewing videos or otherwise experiencing media provided by the content server system 100 in other embodiments. The application 300 requests content associated with the requested media channel from the content server 110. The application 300 receives media items (e.g., the media item is streamed) associated with the requested media channel and presents the media items to the user.

In addition to selecting content and providing it to users of client devices 140, the content server 110 and the application 300 work together to allow users to review and interact with previously-presented ads. In particular, the content server 110 creates an ad review display that is transmitted to the application 300. The application 300 presents the ad review display to the user and allows the user to interact with the ad review display. Interaction with the ad review display enables the user to replay in-stream ads or other media ads by incorporating them into the stream of media content being played on the client device 140.

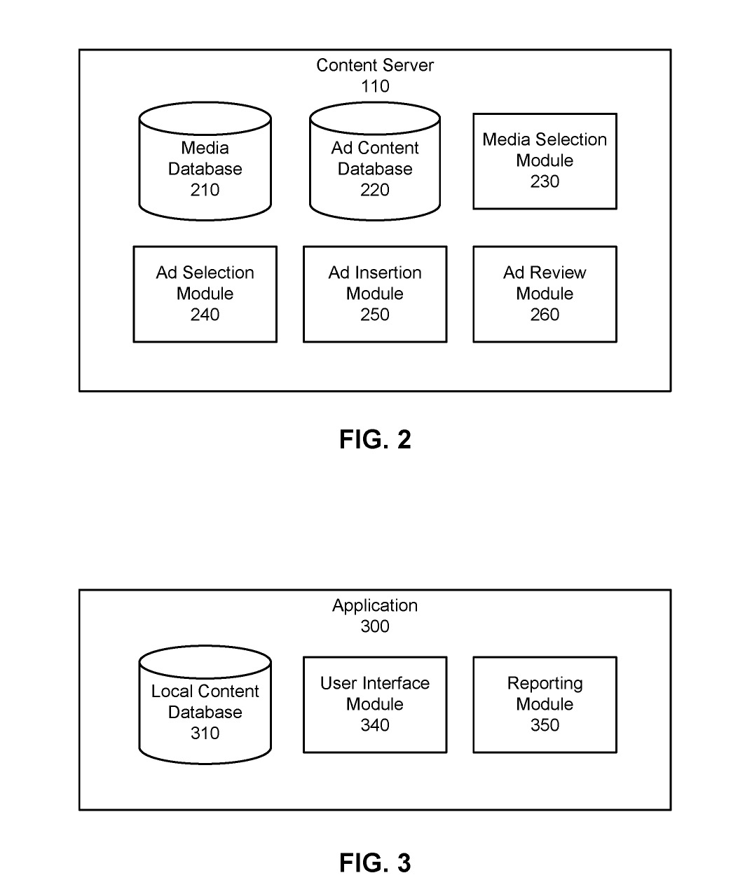

FIG. 2 is a high-level block diagram illustrating a detailed view of the content server 110 of FIG. 1, according to one embodiment. The content server 110 is comprised of modules including a media database 210, an ad content database 220, a media selection module 230, an ad selection module 240, an ad insertion module 250, and an ad review module 260. Some embodiments of the content server 110 have different modules than those described here. Similarly, the functions can be distributed among the modules in a different manner than is described here. Additionally, some components of the content server 110 may be controlled by a third-party entity; for example, the function of the ad selection module 240 may be provided in whole or in part by an ad exchange. Furthermore, the components of the content server 110 are not necessarily implemented on any one device or group of co-located devices. For example, the content server 110 may include a media distribution network that supplies music from geographically dispersed media databases 210.

The media database 210 stores information relating to media items, such as the media items and associated metadata (e.g., artist, name of track, etc.), playlists, and mappings of media items to media features. Media features (also referred to as musicological features) describe musicological characteristics of media items. For example, if the media item is a song, the media features of the song may indicate the underlying musicological characteristics of the song such as e.g., the gender of the singer, the type of background vocals, the tempo, the quality of the tones (e.g., pure or distorted), whether the melody dominates the composition, and an amount of gospel influence. A given media item may have many media features, such as 100-500 media features. In one embodiment, the mapping of media items to media features is established using the MUSIC GENOME PROJECT database created by PANDORA MEDIA, INC. of Oakland, Calif.

In one embodiment, each media item is associated with one or more “media tiles,” which are also stored in the media database 210. A media tile is an item of image content that is visually represents a particular media item. Media tiles can be any sort of image associated with the media item. For example, a media tile for an item of audio content, such as a song, may be an album cover, or a picture of the performing artist, composer or producer. Similarly, a media tile for an item of video content may be a still image of the video content, or a picture of an actor or director from the video content. In some embodiments, media tiles are presented along with the media items they represent. For example, a media tile is displayed on the client device 140 while a song is playing.

The ad content database 220 stores information relating to ads, such as the ad itself, characteristics of the subject of the ad, a landing page to which the ad directs users, and targeting criteria identifying characteristics of users to which the ad is directed. Such ad-related information can be provided to the content server 110 by advertisers 120. Audio ads may be presented with a visual aspect that is displayed on the client device 140 while the audio is being played. In some embodiments, other types of content such as interactive visual content, and animations can be presented as in-stream ads. Ads stored in the ad content database 220 may be grouped by ad campaign, in which multiple ads relate to a same subject, theme, or goal.

Ads are further associated with one or more “ad tiles,” which are also stored in the ad content database 220. An ad tile is an item of image content that is visually represents a particular ad. The ad tile for an ad may or may not be the same as the aforementioned visual aspect that can be displayed on the client device 140 while an audio ad is being played. Ad tiles may be determined based on the advertiser providing the ad, or the ad itself. For example, an ad tile may be the logo of the advertiser providing the ad that the ad tile represents. Ad tiles that are determined based on the ad itself may consider the content that the ad is presenting. For example, an ad tile for a banner ad may be the banner ad itself, or a simplified version of the banner ad. For example, an ad tile for an in-stream ad containing video content may be a still image taken from the video content that is deemed to be representative of the in-stream ad. If the ad does not have a visual content, such as an in-stream audio ad, the ad tile could be an ad tile from a related ad (e.g., another ad in the same ad campaign or from the same advertiser) presenting similar content in a different form, such as a banner ad or an in-stream video ad. In some embodiments, ad tiles for ads that do not have a visual component are displayed while the ad is presented to the user. Furthermore, an ad tile may encourage the user to interact with the ad. For example, the ad tile may display text such as “Click here to learn more!”

The media selection module 230 provides requested media from the media database 210 to a requesting client device 140. If the content server 110 provides streaming audio, for example, then the media selection module 230 selects audio content and streams the selected audio to the client device 140 over time. The media selection module 230 may select media for a user based at least in part on user information (e.g., musical preferences), user requests, and a combination thereof.

In one embodiment, the media selection module 230 generates media playlists and selects audio content from the playlists based on a seed value received from a user of a client device 140. A seed value describes one or more aspects of the content playlist that the user would like formed. Seed values may specify bibliographic information about audio content (e.g., track title, band name, album title) or any term to describe music (e.g., musical genre, historical era, an audio feature). The media selection module 230 extracts audio features from the seed value using a mapping between audio content associated with the seed value and corresponding media features in the media database 210. If the seed value does not describe a single item of audio content, the media selection module 230 retrieves one or more items audio content associated with the seed value. For example, media selection module 230 retrieves one or more representative songs (e.g., of a genre, of a band). The media selection module 230 uses the extracted audio features to dynamically generate a media playlist of audio content having audio features similar to the extracted audio features. For example, given a seed value of a band X, the media selection module 230 locates a song Y by band X and identifies audio features that characterize the song Y. The media selection module 230 may additionally consider user preferences when generating the media playlist.

The ad selection module 240 provides ads to the client device 140. The ad selection module 240 selects ads based on factors such as user profile data, media content provided to the client device 140, and data collected from the client device 140. The ad selection module 240 can select ads for different purposes, for example, to be presented in between items of media content (in-stream ads) or while other media content is playing (banner ads). In one embodiment, the ad selection module 240 selects ads whose targeting criteria (as provided by the advertiser 120) match one or more pieces of user information associated with the client device 140.

The ad insertion module 250 determines where in the stream of media content ads should be presented to the user. In one embodiment, the ad insertion module 250 inserts an ad selected by the ad selection module 240 directly into the stream of media content before it has been delivered to the client device 140. In another embodiment, the ad insertion module 250 inserts a signal causing the application 300 on the client device 140 to insert an ad at that point in the stream of the media content. In response to the signal, the application 300 queries the content server 110 for an ad selected by the ad selection module 240. Alternatively, the application 300 can select an ad locally (i.e., from the local content database 310 of the application 300 described below). Additionally, the signal can indicate what type of media (i.e., audio, video) content the inserted ad should contain.

The ad review module 260 generates an ad review display that allows the user to review and interact with previously-presented ads through the application 300 on the client device 140. The ad review module 260 keeps track of which ads have been presented to the user based on indications received from the application 300. In some embodiments, media items that have been presented to the user are tracked in the same way.

Upon receiving an indication that an ad has been presented from the application 300, the ad review module 260 determines an ad tile for the ad. An ad tile is intended to be a graphical representation of the ad, which may have been initially presented to the user in a different format (i.e., audio, video). Possible ad tiles are discussed in conjunction with ad content database 220 of FIG. 2. The ad review module 260 may select between multiple ad tiles for a single ad based on how closely related the ad tile is to the ad. For example, a still image from a video ad may be given preference over a banner ad from the same ad campaign.

The ad review module 260 stores the ad tiles such that they can be used to generate an ordered list that represents the previously-presented ads that would be displayed in an ad review display. For example, the ad tile can be stored with an identifier of the user to which the corresponding ad was presented and a timestamp indicating when the corresponding ad was presented to the user. The ordered list may be of a set length (i.e., storing a predetermined number of ad and/or media tiles), or cover a set time frame (i.e., all ad and/or media tiles for a predetermined length of time) or number of listening sessions. The ordered list may also be ordered chronologically. In some embodiments, the ad tiles are stored with information that describes relationships between particular tiles, such as those between a media tile and an ad tile for a banner ad that was presented to the user while the media item associated with the media tile was playing.

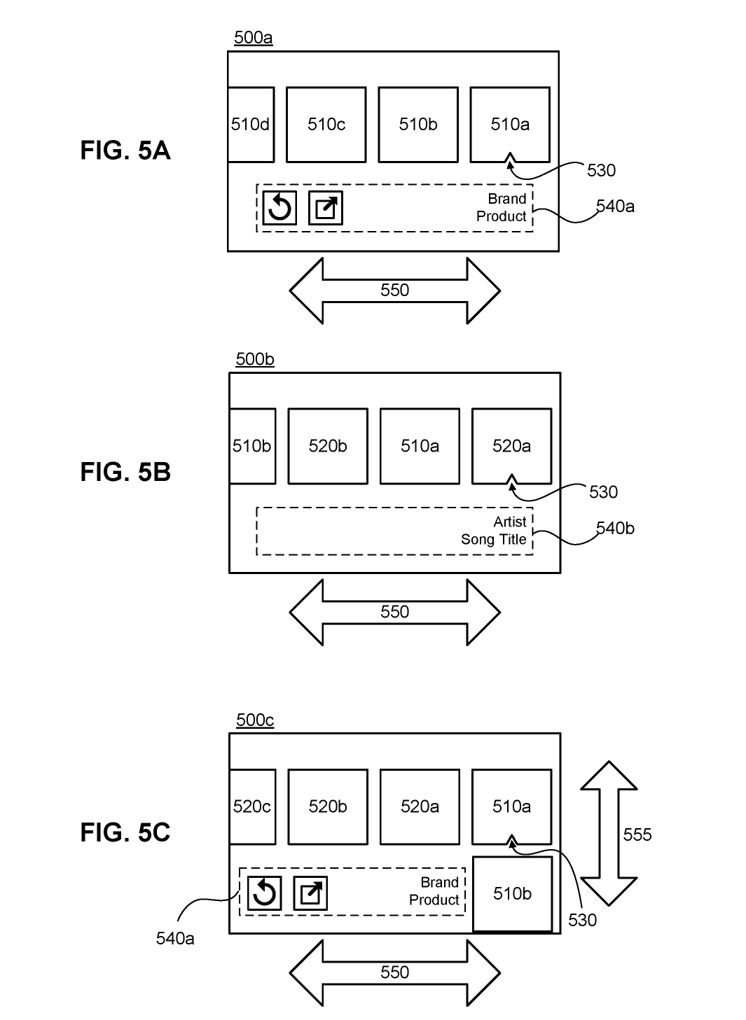

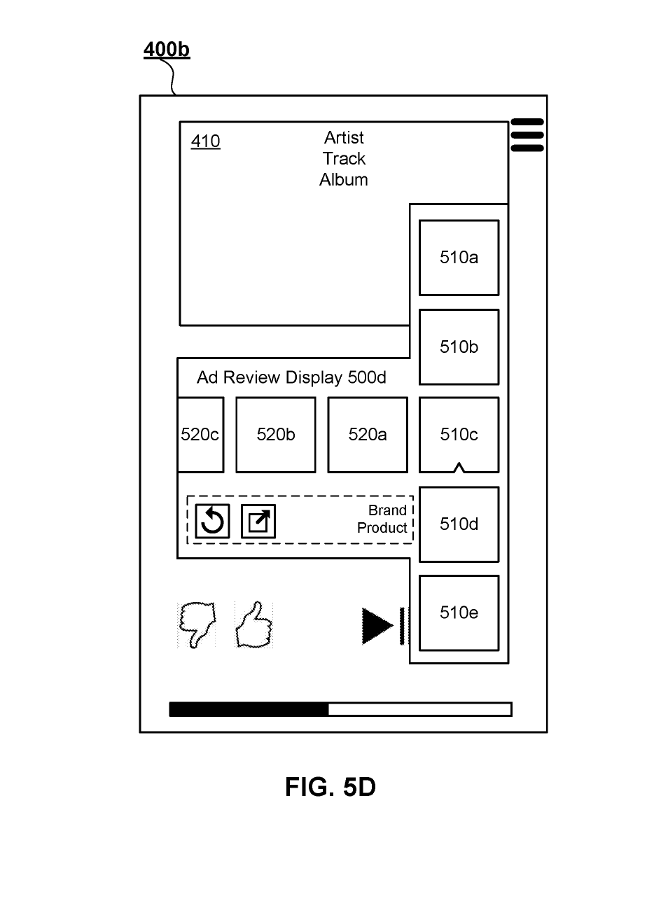

An ad review display is generated by the ad review module 260 based on the order of the tiles in the ordered list. Ad review display layouts are described in more detail in conjunction with FIGS. 5A-C. In some embodiments, the ordered list also includes media tiles that correspond to media items that are part of the stream of media content. Thus, the media tiles and ad tiles may be interspersed in the ordered list depending on when they were presented to the user.

Upon receipt of a request to replay an ad from the client device 140, the ad review module 260 retrieves the ad from the ad content database 220 and inserts it into the stream of media content being provided to the client device 140. In one embodiment, the ad is inserted in the next natural break in the media content (i.e., between songs or videos). In another embodiment, the ad interrupts the stream of media content and begins playing immediately. The ad review module 260 may also keep track of ads that have been replayed.

FIG. 3 is a high-level block diagram illustrating a detailed view of the application 300 on the client device 140 of FIG. 1, according to one embodiment. The application 300 includes a local content database 310, a user interface 320, and a reporting module 330. Some embodiments of the application 300 have different modules than those described here. Similarly, the functions can be distributed among the modules in a different manner than is described here.

The local content database 310 stores content locally on the client device 140. This content can include ads, media items, and associated information, as discussed with respect to the media database 210 and ad content database 220 of the content server 110. Specifically, the local content database 310 stores ad tiles and media tiles associated with the ads and media items, respectively, that are received from the content server 110.

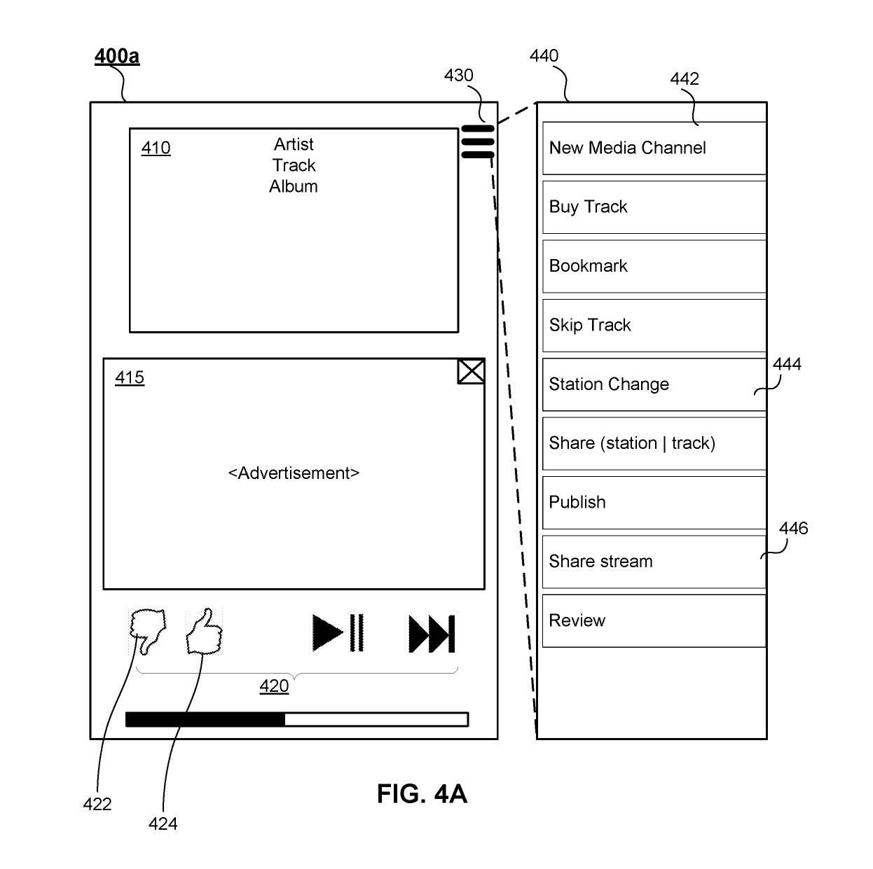

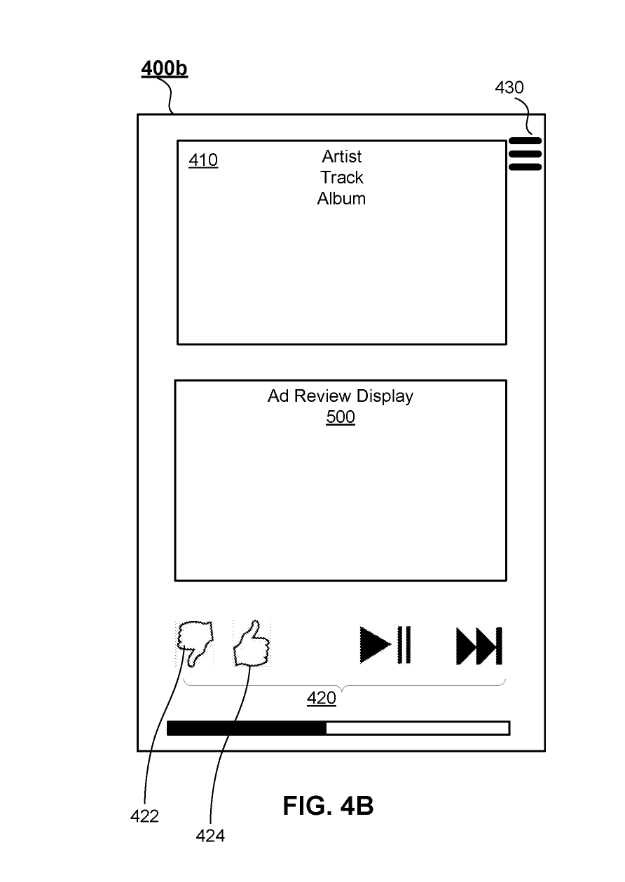

The user interface module 320 generates a user interface that presents content to the user and facilitates interaction between the user and the content server 110. For example, the application 300 provides a graphical user interface for interacting with an audio stream. The user interface displays information about media and ads being presented to the user, and may also provide playback controls (e.g., pause, skip, play) and feedback controls (e.g., like, dislike, favorite, rate, share, bookmark) to indicate the user's positive, negative, or indifferent reaction to a song. In one embodiment, a user may request a playlist through the user interface by providing a seed value used by the content server 110 to generate a content playlist. The user interface also allows the user to review and interact with ads that have been previously presented to the user. The user interface generated by the user interface module 320 is described in more detail below, by way of example, in conjunction with FIGS. 4A-B and 5A-C.

The reporting module 330 transmits usage data to the content server 110. Usage data includes feedback received through the user interface. Feedback include explicit feedback (from a dedicated feedback in the user interface) or implicit (e.g., skipping a song, sharing a song). The content server 110 generates and selects ads based at least in part on the transmitted usage data.

Usage data can also include ad information, such as which ads were presented and any interactions the user had with the ads (i.e., clicking on, reviewing or replaying the ad). In particular, the reporting module 330 sends an indication to the content server 110 when an ad has been presented to the user. The indication includes a specific ad, and can also include a timestamp denoting when the ad was presented to the user. In one embodiment, the indication is triggered by the application 300 on the client device 140 presenting the ad to the user in substantially real-time. In other embodiments, the indications may not be sent to the content server 110 in substantially real-time. Responsive to an interaction that indicates that the user wishes to replay a particular ad, the reporting module 330 sends a request to replay the ad to the content server 110.

### User Interface for Reviewing Advertisements

FIGS. 4A-B are example user interfaces 400 provided by the application 300 of FIGS. 1 and 3, according to one embodiment. The example user interface 400a shown in FIG. 4A includes a description area 410 providing information on a currently-playing song, a banner ad 415, and controls 420. In one embodiment, the banner ad 415 overlaps the description area 410. Controls 420 allow the user to log appreciation for the song currently playing (via a thumbs up button 424), log dislike of (via a thumbs down button 422) the song currently playing, and to pause/play or skip the current song. The thumbs up button 424 and the thumbs down button 422 enable the user to provide express feedback about the media item being presented.

The example user interface 400a also includes a set of options 440 (shown in response to selection of popup control 430) that include an option 442 to request an audio stream that includes songs (tracks) associated with a particular media channel, and an option 446 to share a stream with other users of the content server 110 so that the other users can also (for example) react to the currently-playing song, such as logging appreciation for, or dislike of, the song, sharing the song, bookmarking the song, or the like. The set of options 440 also include an option 444 to change to a different station (i.e., media channel).

The example user interface 400b shown in FIG. 4B differs from example user interface 400a from FIG. 4A by including an ad review display 500. The ad review display 500 allows users to review and interact with previously-presented ads. The ad review display 500 displays ad tiles that represent ads that have been presented to the user. A user can choose to review a particular ad by selecting the corresponding ad tile in the ad review display. In some embodiments, the ad review display 500 also allows users to review media items that have been presented to them by displaying media tiles along with the ad tiles. Users can interact with the example user interface 400b by scrolling tiles horizontally or vertically, as well as selecting tiles, or links or buttons associated with the tiles. Example ad review displays 500 are discussed in further detail in conjunction with FIGS. 5A-D.

The example user interface 400b may be reached through the example user interface 400a (i.e., a user interface screen presented in response to a selecting the “Review” button on the example user interface 400a), such that the ad review display 500 is not accessible at all times. In some embodiments, the ad review display 500 is presented on its own user interface screen that is separate from the user interface screen that shows description area 410.

FIGS. 5A-D are example ad review displays 500 in the example user interface 400b of FIG. 4B, according to one embodiment. Each example ad review display 500 is generated by the content server 110 and illustrates a different embodiment of displaying ad and/or media tiles that allows users to review previously-presented ads and/or media items.

Example ad review display 500a, shown in FIG. 5A, comprises an ordered display of ad tiles 510. The ad tiles 510 are positioned adjacent to each other along a horizontal 550 axis that represents time. The order of ad tiles 510 along the horizontal 550 axis conveys the order that ads corresponding to the ad tiles 510 were presented to the user. Ad tile 510a is located on the rightmost side of the example ad review display 500a because it corresponds to the ad that was presented to the user most recently (of the ads represented by ad tiles 510 visible in the example ad review display 500a). Similarly, ad tile 510a is located on the leftmost side of the example ad review display 500a because it corresponds to the ad that was presented to the user least recently (of the ads represented by ad tiles 510 visible in the example ad review display 500a).

In some embodiments, a set number of ad tiles 510 are included in the example ad review display 500a. The number may be chosen arbitrarily (i.e., the most recent 10 ad tiles 510), or be based on the size of the example ad review display 500a (e.g., the example ad review display 500a only presents as many ad tiles 510 as can be displayed in the example ad review display 500a simultaneously). In other embodiments, the example ad review display 500a includes ad tiles 510 corresponding to all of the ads that have been presented to a user in a particular time period. This time period may similarly be chosen arbitrarily (i.e., the last hour), or be based on the length of time the user has been continuously streaming media content (e.g., the length of a listening session).

The example ad review display 500a further comprises an indicator 530 and a information display 540. The indicator 530 works to visually distinguish one ad tile 510a from the other ad tiles 510 and allows the user to select an ad about which to view more information. Though the indicator 530 is shown as a triangular indentation on the ad tile 510a, the indicator 530 can also visually highlight a particular ad tile 510 in other ways, such as changing the color of the ad tile 510a, making ad tile 510a bigger, darkening the outline of the ad tile 510a, and so on. The information display 540 contains information pertaining to the specific ad tile 510a that is selected by the indicator 530. Information display 540a is associated with an ad tile 510a and includes descriptive information about the ad associated with the ad tile 510a, such as the subject of the ad (e.g., product, business, service, etc.), and the advertiser 120 providing the ad (e.g., brand, business, service provider, etc.). The information display 540a can also include links or buttons to that allow the user to interact with the ad associated with the visually distinguished ad tile 510a. Specifically, the information display 540a can include a replay button that requests that the ad be replayed in the stream of media content, or a landing page button that navigates the user to a landing page associated with the ad. In one embodiment, the information display 540 is positioned directly below the ordered display of ad tiles 510.

The user can interact with the example ad review display 500a in a number of ways that allow the user to gather more or different information about previously-presented ads. The user can scroll horizontally 550 to shift the ordered display of ad tiles 510 so that the indicator 530 is associated with a different ad tile 510. Alternatively, the user can move the indicator 530 along the horizontal 550 axis instead of the ordered display of ad tiles 510. Additionally, a user can scroll horizontally 550 through the ad tiles 510 in the ordered display list to see all of the ads that displayed in the example ad review display 500a.

Example ad review display 500b, shown in FIG. 5B, is similar to example ad review display 500a. However, instead of the ordered display only including ad tiles 510, the ordered display of example ad review display 500b also includes media tiles 520. Thus, in example ad review display 500b, the user is able to review ads in the context of the media items that were also presented to them.

Additionally, because indicator 530 visually highlights media tile 520a, the descriptive information presented in the information display 540b differs from the descriptive information presented in information display 540a, which pertains to an ad tile 510. Descriptive information for a media item depends on the type of media item. For example, descriptive information for a song could include track, album and artist names, as well as genre, which descriptive information for a short film could include a title, and the names of the cast and crew. However, if indicator 530 visually distinguishes an ad tile 510a, the information display 540b would be replaced with information display 540a from example ad review display 500a.

Example ad review display 500c, shown in FIG. 5C, is similar to example ad review display 500b. However, example ad review display 500c also has ad tiles 510 organized along one or more vertical 555 axes aligned with ad tiles 510 organized along the horizontal 550 axis. Specifically, the example ad review display 500c displays an additional ad tile 510b along a vertical 555 axis aligned with ad tile 510a. Ad tile 510a corresponds to a previously-presented ad, while the additional ad tile 510b, on the other hand, corresponds to an additional ad that is related to the ad represented by ad tile 510a and may not otherwise have been included in the ordered display. For example, the additional ad may have never been or not recently presented to the user. The user can then review the additional ad by scrolling vertically 555 such that the indicator 530 specifies the additional ad tile 510b. In some embodiments, ad tiles 510 aligned along a vertical 555 axis are only shown in the ordered display when the indicator 530 designates an ad tile 510 that is also along that vertical 555 axis (e.g., the ad tile 510 in the rightmost position).

This functionality is particularly useful when an advertiser 120 creates a multi-part ad campaign or “story,” which comprises several different ads that are meant to be presented in a particular order. For example, if the ads corresponding to ad tiles 510a and 510b are part of the same ad story, the user can interact with ad tile 510b to see the next installment in the ad story even though that ad may not have been presented to the user.

Example ad review display 500d, shown in FIG. 5D, is a variation of example ad review display 500c. The ad tiles 510 that are arranged vertically 555 “pop out” of the space allotted for the example ad review display 500d such that they cover other aspects of the user interface 400b. This pop-out interface allows users to view more ad tiles 510 at the same time. In some embodiments, ad tiles 510 aligned along a vertical 555 axis only pop out when the indicator 530 designates an ad tile 510 that is also along that vertical 555 axis (e.g., the ad tile 510 in the rightmost position). In one embodiment, the ad tiles 510 also only pop out when the user is actively scrolling along the vertical 555 axis, such that the ad tiles do not always obscure other content on the user interface screen 400b.

Features of the example ad review displays 500 described may be further combined or modified. For example, another embodiment of example ad review display 500c (or 500d) may only have ad tiles 510 organized along the horizontal axis 550, instead of both ad tiles 510 and media tiles 520 as shown in FIGS. 5C-D. Additionally, one embodiment of example ad review display 500c (or 500d) may also have vertical 555 axes aligned with media tiles 520 such that other related media tiles 520 or related ad tiles 510 can be shown in associated with the media tiles 520 along the horizontal axis. Examples of related media tiles 520 include media tiles 520 for other songs from the same album or by the same artist. Examples of ad tiles 510 that are related to media tiles 520 include ads that may have been shown while the media item was playing (i.e., banner ads). In a specific variation of this embodiment, ad tiles 510 for in-stream ads and media tiles 520 are organized along the horizontal 550 axis, while related ad tiles 510 are organized along the vertical 555 axes of ad tiles 510 and ad tiles 510 for banner ads are organized along the vertical 555 axes of media tiles 520. Yet another embodiment of example ad review display 500c (or 500d) may only have media tiles 510 organized along the horizontal 550 axis, with ad tiles 510 being displayed along vertical 555 axes aligned with the media tiles 520.

### Method for Displaying Advertisements for Review

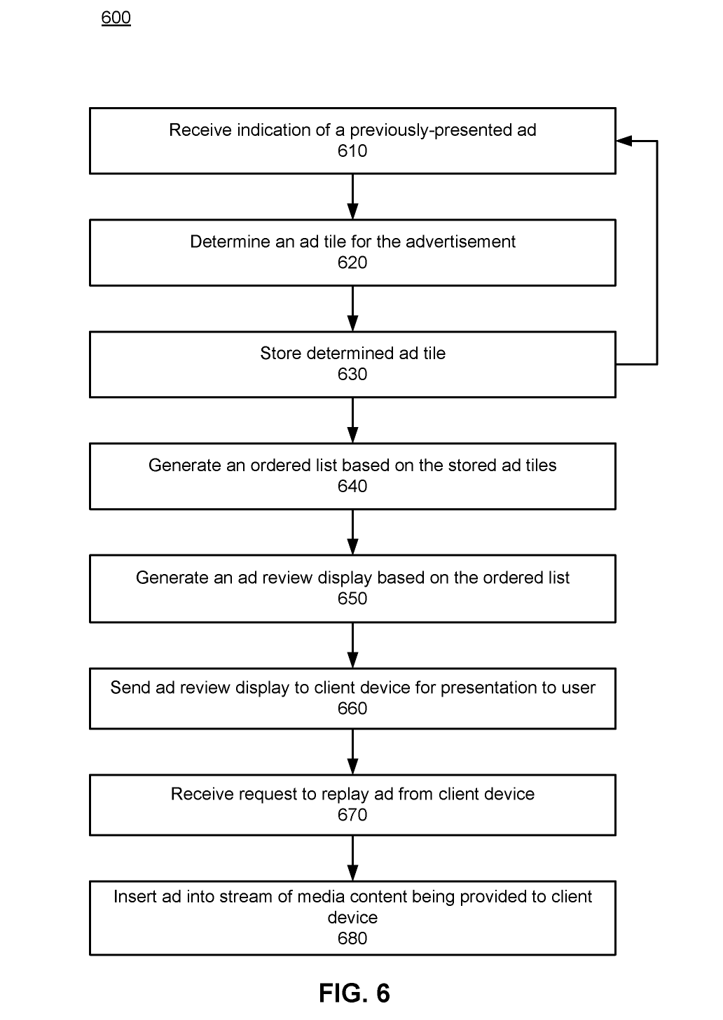

FIG. 6 is a flowchart illustrating a method 600 for enabling users to review previously-presented ads, according to one embodiment. Method 600 begins when the content server 110 receives 610 an indication of a previously-presented ad from the application 300 on the client device 140. The content server 110 then determines 620 an ad tile for the ad specified in the received 610 indication. The determined 620 ad tile is stored 630 based on when the corresponding ad was presented to the user of the client device 140. Steps 610-630 are repeated as necessary for a plurality of ads that have been presented to the user.

The content server 110 generates 640 an ordered list from the stored 630 ad tiles. The ordered list reflects the order in which the corresponding ads were presented to the users of the client device. The content server then generates 650 an ad review display based on the ordered list. In some embodiments, the ordered list stores both ad tiles and media tiles, and thus the generated 650 ad review display includes both ad tiles and media tiles. The generated 650 ad review display is sent 660 from the content server 110 to the application 300 for presentation to the user on the client device 140. The ad review display can be presented to the user in various layouts, examples of which are described in conjunction with FIGS. 5A-C.

The content server 110 receives 670 a request to replay an in-stream ad represented in the ad review display from the application 300. Responsive to this request, the content server 110 inserts 680 the requested ad into the stream of media content being provided to the user through the application 300 on the client device 140. In some embodiments, the requested ad is inserted 680 into the next natural break in the stream of media content (i.e., between media items), while in other embodiments, the requested ad is inserted 680 immediately and interrupts the stream of media content.

In some embodiments, the above steps are performed by a combination of the content server 110 and the application 300. For example, steps 610-660 may be performed by the application 300, while steps 670-680 are performed by the content server 110. In such cases, the steps of method 600 may be modified to better match the capabilities of the application 300. Alternatively, additional or substitute steps may be used in method 600 as appropriate based on the functionality described in conjunction with the previous description.

### Example Computer

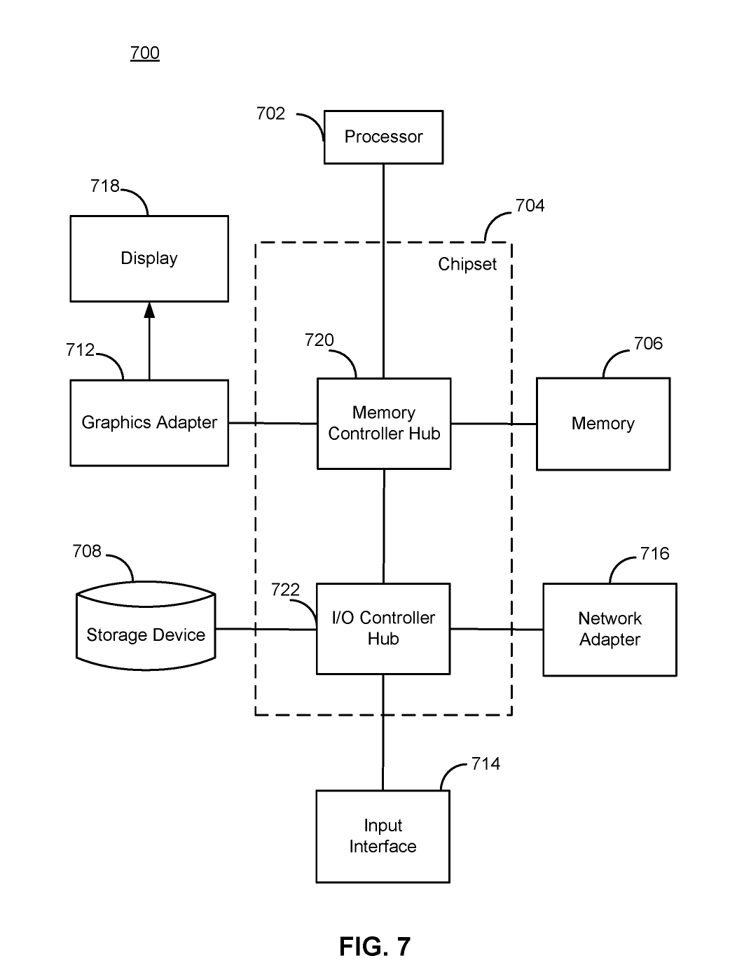

FIG. 7 is a high-level block diagram illustrating an example computer 700 for implementing the entities shown in FIG. 1. The computer 700 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, an input device 714, and network adapter 716 are coupled to the I/O controller hub 722. Other embodiments of the computer 700 have different architectures.

The storage device 708 is a non-transitory computer-readable storage medium such as a hard drive, compact disk read-only memory (CD-ROM), DVD, or a solid-state memory device. The memory 706 holds instructions and data used by the processor 702. The input interface 714 is a touch-screen interface, a mouse, track ball, or other type of pointing device, a keyboard, or some combination thereof, and is used to input data into the computer 700. In some embodiments, the computer 700 may be configured to receive input (e.g., commands) from the input interface 714 via gestures from the user. The graphics adapter 712 displays images and other information on the display 718. The network adapter 716 couples the computer 700 to one or more computer networks.

The computer 700 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 708, loaded into the memory 706, and executed by the processor 702.

The types of computers 700 used by the entities of FIG. 1 can vary depending upon the embodiment and the processing power required by the entity. For example, the content server 110 can run in a single computer 700 or multiple computers 700 communicating with each other through a network such as in a server farm. The computers 700 can lack some of the components described above, such as graphics adapters 712, and displays 718.

### Other Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for selecting content based on correlations between preferred media features and specific configurations of environmental information. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A computer-implemented method comprising:
providing a stream of media content to a client device for presentation to a user of the client device;
generating an ordered list comprising a plurality of ad tiles corresponding to a plurality of previously-presented ads, the previously-presented ads having been presented to the user in conjunction with the stream of media content;
generating an ad review display based on the ordered list, the ad review display comprising one or more ad tiles of the plurality of ad tiles organized along a first axis of the ad review display according to their position in the ordered list;
sending the ad review display to the client device for presentation to the user;
receiving, from the client device, a request to replay a first ad; and
inserting the first ad into the stream of media content being provided to the client device.

2. The computer implemented method of claim 1, wherein inserting the first advertisement into the stream of media content comprises:
interrupting a media item of the stream of media content that is currently being played on the client device; and
presenting the first advertisement in the stream of media client in place of the interrupted media item.

3. The computer implemented method of claim 1, wherein inserting the first advertisement into the stream of media content comprises inserting the first advertisement between two media items of the stream of media content.

4. The computer implemented method of claim 1, wherein the generated ad display further comprises one or more additional ad tiles organized along one or more second axes of the ad review display, each second axis aligning with an ad tile along the first axis of the ad review display, each of the one or more additional ad tiles corresponding to an advertisement related to the advertisement represented by the ad tile along the first axis with which they are aligned.

5. The computer implemented method of claim 1, wherein the ordered list further comprises one or more media tiles, each media tile corresponding to a media item, the ad display further comprising the one or more media tiles organized along the first axis interspersed with the plurality of ad tiles.

6. The computer implemented method of claim 5, wherein the ad display further comprises one or more additional ad tiles of the plurality of ad tiles organized along one or more second axes of the ad review display, each second axis aligning with a media tile along the first axis of the ad review display, each of the one or more additional ad tiles corresponding to an advertisement presented in conjunction with the media item represented by the media tile along the first axis with which they are aligned.

7. The computer implemented method of claim 6, wherein ad tiles organized along the first axis represent in-stream advertisements.

8. The computer implemented method of claim 6, wherein ad tiles organized along the second axes represent banner advertisements.

9. The computer implemented method of claim 1, the request is received responsive to a user selection of an ad tile in the ad review display.

10. A non-transitory computer-readable storage medium comprising instructions that when executed by a processor cause the processor to:
provide a stream of media content to a client device for presentation to a user of the client device;
generate an ordered list comprising a plurality of ad tiles corresponding to a plurality of previously-presented ads, the previously-presented ads having been presented to the user in conjunction with the stream of media content;
generate an ad review display based on the ordered list, the ad review display comprising one or more ad tiles of the plurality of ad tiles organized along a first axis of the ad review display according to their position in the ordered list;
send the ad review display to the client device for presentation to the user;
receive, from the client device, a request to replay a first ad; and
insert the first ad into the stream of media content being provided to the client device.

11. The non-transitory computer-readable storage medium of claim 10, wherein the instructions to insert the first advertisement into the stream of media content comprise instructions to:
interrupt a media item of the stream of media content that is currently being played on the client device; and
present the first advertisement in the stream of media client in place of the interrupted media item.

12. The non-transitory computer-readable storage medium of claim 10, wherein the instructions to insert the first advertisement into the stream of media content comprise instructions to insert the first advertisement between two media items of the stream of media content.

13. The non-transitory computer-readable storage medium of claim 10, wherein the generated ad display further comprises one or more additional ad tiles organized along one or more second axes of the ad review display, each second axis aligning with an ad tile along the first axis of the ad review display, each of the one or more additional ad tiles corresponding to an advertisement related to the advertisement represented by the ad tile along the first axis with which they are aligned.

14. The non-transitory computer-readable storage medium of claim 10, wherein the ordered list further comprises one or more media tiles, each media tile corresponding to a media item, the ad display further comprising the one or more media tiles organized along the first axis interspersed with the plurality of ad tiles.

15. The non-transitory computer-readable storage medium of claim 14, wherein the ad display further comprises one or more additional ad tiles of the plurality of ad tiles organized along one or more second axes of the ad review display, each second axis aligning with a media tile along the first axis of the ad review display, each of the one or more additional ad tiles corresponding to an advertisement presented in conjunction with the media item represented by the media tile along the first axis with which they are aligned.

16. The non-transitory computer-readable storage medium of claim 15, wherein ad tiles organized along the first axis represent in-stream advertisements.

17. The non-transitory computer-readable storage medium of claim 15, wherein ad tiles organized along the second axes represent banner advertisements.

18. The non-transitory computer-readable storage medium of claim 10, wherein the request is received responsive to a user selection of an ad tile in the ad review display.

19. A system comprising:
a processor; and
a non-transitory computer-readable storage medium comprising instructions that when executed by the processor cause the processor to:
provide a stream of media content to a client device for presentation to a user of the client device;
generate an ordered list comprising a plurality of ad tiles corresponding to a plurality of previously-presented ads, the previously-presented ads having been presented to the user in conjunction with the stream of media content;
generate an ad review display based on the ordered list, the ad review display comprising one or more ad tiles of the plurality of ad tiles organized along a first axis of the ad review display according to their position in the ordered list;
send the ad review display to the client device for presentation to the user;
receive, from the client device, a request to replay a first ad; and
insert the first ad into the stream of media content being provided to the client device.

20. The system of claim 19, wherein the instructions to insert the first advertisement into the stream of media content comprise instructions to:
interrupt a media item of the stream of media content that is currently being played on the client device; and
present the first advertisement in the stream of media client in place of the interrupted media item.
